(19) United States
(12) Patent Application Publication
(10) Pub. No.: US 2017/0051416 A1
(43) Pub. Date: Feb. 23, 2017

(54) System for hydrogen gas (H2) production from seawater

(71) Applicant: Michael E. Thomas, Pocomoke City, MD (US)

(72) Inventor: Michael E. Thomas, Pocomoke City, MD (US)

(21) Appl. No.: 14/756,225

(22) Filed: Aug. 20, 2015

(51) Int. Cl. C25B 1/04; H01M 8/06

(52) U.S. Cl. CPC C25B 1/04; H01M 8/0656

(57) ABSTRACT

A seawater feedstock input is provided to accurately supply seawater from an input seawater feedstock supply. The seawater feedstock will be used for the production of hydrogen gas (H₂) from seawater. The seawater feedstock could be acidified as shown with concentration of ionized hydrogen ions in the seawater

CO_{2(aq)}+H₂O [symbol] H₂CO₃ [symbol] HCO₃⁻+H⁺ [symbol] CO₃²⁻+2 H⁺

and that this increased ionized hydrogen (H+) can be included in the production of hydrogen gas (H₂) from seawater that will be used in today's fuel cell technologies, transportation, power plants, and space propulsion technologies, as well as, other technologies. The proposed process is to be duplicated and utilized in a unique scientifically engineered dissociation hydrogen gas (H₂) production system.

### CROSS-REFERENCES TO RELATED APPLICATION

JP58025073 (A) February 1983 KEIICHI

“In situ hydrate dissociation using microwave heating: Preliminary study”, Dong-Liang Li, Science Direct, Energy Conversion and Management The Hydrogen Society, H2ydrogeit, Verlag, Arvo A. Evers ISBN 978-3,937863-31-3, 16727 Oberkraemer, Prof. T. Nejat Veriroglu, Germany 2010.

“Commercializing technology to dissociate methane into nano-carbon and hydrogen, avoiding CO2 generation, Atlantic Hydrogen, August 2009.

National Geographic, Ocean Acidification Carbon Dioxide Is Putting Shelled Animals at Risk http://ocean.nationalgeographic.com/ocean/critical-issues-ocean-acidification/National Oceanic and Atmospheric Organization, What is Ocean Acidification http://www.pmel.noaa.gov/co2/story/What+is+Ocean+Acidification%3F

Caldeira, K.; Wickett, M. E. (2003). “Anthropogenic carbon and ocean pH”. Nature 425 (6956): 365-365. bibcode:2001agufmos11c0385c. doi:10.1038/425365a. pmid 14508477.

Millero, Frank J. (1995). “Thermodynamics of the carbon dioxide system in the oceans”. geochimica et cosmochimica acta 59 (4): 661-677. bibcode:1995gecoa..59..661m. doi:10.1016/0016-7037(94)00354-o.

Feely, R. A.; et al. (July 2004). “Impact of Anthropogenic CO₂ on the CaCO₃ System in the Oceans”. Science 305 (5682): 362-366. bibcode:2004sci...305..362f. doi:10.1126/science.1097329. pmid 15256664.

Jacobson, M. Z. (2005). “Studying ocean acidification with conservative, stable numerical schemes for nonequilibrium air-ocean exchange and ocean equilibrium chemistry”. Journal of Geophysical Research—Atmospheres 110: D07302. Bibcode:2005JGRD..11007302J. doi:10.1029/2004JD005220.

Hall-Spencer, J. M.; Rodolfo-Metalpa, R.; Martin, S.; et al. (July 2008). “Volcanic carbon dioxide vents show ecosystem effects of ocean acidification”. Nature 454 (7200): 96-9. Bibcode:2008Natur.454...96H. doi:10.1038/nature07051. PMID 18536730.

Report of the Ocean Acidification and Oxygen Working Group, International Council for Science's Scientific Committee on Ocean Research (SCOR) Biological Observatories Workshop.

Mora, C (2013). “The projected timing of climate departure from recent variability”. Nature 502: 183-187. doi:10.1038/nature12540.

Mora, C. et al. (2013). “Biotic and Human Vulnerability to Projected Changes in Ocean Biogeochemistry over the 21st Century”. PLoS Biology 11: e1001682. doi:10.1371/journal.pbio.1001682.

Orr, James C.; et al. (2005). “Anthropogenic ocean acidification over the twenty-first century and its impact on calcifying organisms”. Nature 437 (7059): 681-686. Bibcode:2005Natur.437..6810. doi:10.1038/nature04095. pmid 16193043. Archived from the original on 2008-06-25.

Cornelia Dean (January 30, 2009). “Rising Acidity Is Threatening Food Web of Oceans, Science Panel Says”. New York Times.

Robert E. Service (13 July 2012). “Rising Acidity Brings and Ocean Of Trouble”.

Science 337 (6091): 146-148. Bibcode:2012Sci...337..146S. doi:10.1126/science.337.6091.146. PMID 22798578.

IAP (June 2009). “Interacademy Panel (IAP) Member Academies Statement on Ocean Acidification”., Secretariat: TWAS (the Academy of Sciences for the Developing World), Trieste, Italy.

Zachos, J. C.; Röhl, U.; Schellenberg, S.A.; Sluijs, A.; Hodell, D.A.; Kelly, D.C.; Thomas, E.; Nicolo, M.; Raffi, I.; Lourens, L. J.; McCarren, H.; Kroon, D. (2005). “Rapid acidification of the ocean during the Paleocene-Eocene thermal maximum”. Science 308 (5728): 1611-1615. doi:10.1126/science.1109004. PMID 15947184.

Raven, J. A. et al. (2005). Ocean acidification due to increasing atmospheric carbon dioxide. Royal Society, London, UK.

DiMascio, Felice; Willauer, Heather D. ; Hardy, Dennis R. ; Lewis, M. Kathleen; Williams, Frederick W. (Jul. 23, 2010). Extraction of Carbon Dioxide from Seawater by an Electrochemical Acidification Cell. Part 1—Initial Feasibility Studies (memorandum report). Washington, DC: Chemistry Division, Navy Technology Center for Safety and Survivability, U.S. Naval Research Laboratory. Retrieved Sep. 7, 2012.

Willauer, Heather D.; DiMascio, Felice; Hardy, Dennis R.; Lewis, M. Kathleen; Williams, Frederick W. (April 11, 2011). Extraction of Carbon Dioxide from Seawater by an Electrochemical Acidification Cell. Part 2—Laboratory Scaling Studies (memorandum report). Washington, DC: Chemistry Division, Navy Technology Center for Safety and Survivability, U.S. Naval Research Laboratory. Retrieved Sep. 7, 2012.

Thomas, Michael E. self-addressed letter dated March 11, 2015 for extraction of hydrogen from acidified seawater using a membrane filter.

### BACKGROUND OF THE INVENTION

The number one priority of the World is energy independence and security through innovative technologies that create clean jobs, clean energy, and gives economic opportunity for growth. The invention has a unique, innovative, proprietary solution to this problem by producing hydrogen (H₂) from acidified seawater with very little energy input being required. As you know, ever-increasing population growth and global industrialization continue to create a huge demand for energy. Specifically, today's drilling for fossil fuels is unsustainable and pollutive sources of energy. The invention proposes production of scientifically engineered hydrogen gas (H₂) for a viable solution in sustainable nearly emissions-free energy. The largest current demand for fuel includes methods of producing substantial quantities of hydrocarbon fuels which are becoming cost prohibitive and unstable requiring drilling, localized billion dollar refineries, radical market price swings, and must be transported to the location for use to meet customer demand (Keystone Pipeline). To this end, the present invention is a unique dissociation technology that will produce hydrogen (H₂) from acidified seawater CO_{2(aq)}+H₂O [symbol] H₂CO₃ [symbol] HCO₃⁻+H⁺ [symbol] CO₃²⁻+2 H⁺ containing ionized hydrogen gas (H+) in high volumes at low costs produced at the location where the hydrogen gas (H₂) will be needed satisfying evolving PEM (Proton exchange membrane also known as polymer electrolyte membrane) fuel cell demand worldwide. The Department of Energy's molecular hydrogen gas production cost target goal of $4.00 a Kg will be more costly than the $0.30 Kg targeted by this invention. Using the cost numbers of $0.00 for free acidified seawater feed stock with $ 50 hr. electricity cost will lead to hydrogen (H₂) production available for sale at $ 0.30 Kg price. The patent application will be pioneering hydrogen (H₂) production that can be used by fuel cell automobiles, trucks, planes, trains, ships, and power plants. Seawater is a worldwide FREE feedstock material unregulated, taxed or controlled by any country in the world. Expectations are to make continuing discoveries in dissociation physics that can work towards solving better ocean chemistry allowing for improved conditions of all ocean aquatic environments as one of the goals. The benefit of this unique nanotechnology to the world is energy independence, a stable energy supply, protection of the world's oceans, political stability, and security. The world's first known scientifically engineered seawater de-acidification system expects to develop a methodology that can deliver substantial quantities of low cost renewable hydrogen (H₂) gas from seawater, brine or brackish water. This will greatly add to the strength and financial stability of the world and decrease dependence on hydrocarbon drilling, mining, expensive geopolitical refineries, toxic waste, and environmental disasters in the world's thirst for hydrocarbons. The world as a whole will benefit because seawater, as an energy resource, exists in abundance and is an underutilized feedstock resource by the world. Certification-of-the-concept using a prototype has successfully been built and tested, the invention envisions a time when scientifically engineered hydrogen (H₂) gas fuel will help to reduce acidification, increase higher quality energy generation and controlling energy cost forever using an infinite renewable seawater feedstock source. Our scientific dissociation technology is focused on actual low cost localized site production of hydrogen (H₂) gas fuel that can compete with other worldwide energy sources in the market place, which will lead to tangible, disruptive, and cleaner renewable hydrogen (H₂) gas energy products. The process of producing hydrogen (H₂) gas from acidified seawater and the returning of de-acidified seawater to the ocean preserving important chemical balances necessary to the marine aquatic environment.

### OBJECT OF THE INVENTION

It is the object of the present invention to provide unique improvements in all of the above-mentioned areas and to produce hydrogen gas (H₂) from acidified seawater feed stock that uniquely out performs all known hydrogen gas (H₂) production technologies in the state of the art as it now exists.

### BRIEF SUMMARY OF THE INVENTION

The invention is a “disruptive innovation” meeting the United Nation's mission of ensuring political security, environmental protection and prosperity for all the World's populations by allowing countries to remove themselves from chaotic geo-political issues related to foreign oil importation. Our unique patent application process will allow us to produce hydrogen gas (H₂) inexpensively, efficiently, and in high volumes from seawater. Hydrogen gas (H₂) production capabilities can provide unlimited renewable hydrogen energy helping to preserve the World's populations and environment. Our technology will create a conduit for a new energy paradigm held by, produced by, used by, and controlled by independent Countries of the World.

### BRIEF DESCRIPTION OF THE SEVERAL VIEWS OF THE DRAWING

The accompanying drawings, which are incorporated in and form a part of the specification, illustrate the embodiment of the invention and, together with the description, serve to explain the principles of the invention. In the drawings:

FIG. 1 is an overall block diagram of an exemplary hydrogen gas (H₂) production system using seawater feedstock in accordance with the present invention;

### DETAILED DESCRIPTION OF THE INVENTION

Although only a few presently preferred exemplary embodiments have been discussed in schematic detail above, those of ordinary skill in the art will certainly realize that many modifications are possible without departing from the scope and spirit of the present invention as defined in the following.

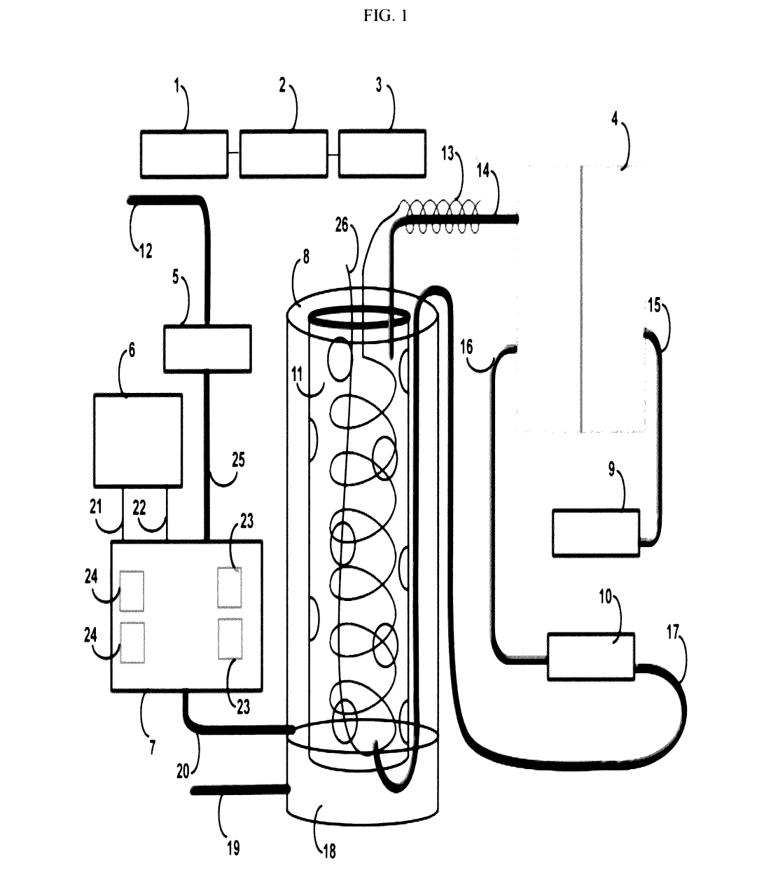

FIG. 1 is an overall block diagram of a presently preferred exemplary embodiment of a hydrogen gas (H₂) production system schematic process using acidified seawater and to recover the suspended hydrogen ions (H+) in the production of hydrogen gas (H₂) in the seawater accordance with the present invention. Referring to FIG. 1, includes overall schematic of a solar photo-voltaic Panel 1, charge inverter controller 2, +12 volt and −12 volt power supply 3, proton exchange membrane (PEM) fuel cell 4, vacuum pump 5, dissociation controller 6, dissociator 7, hydrogen (H₂) collection tank 8, air pump (atmospheric) 9, vacuum pump 10, hydrogen collection tank diffuser 11, acidified seawater feedstock by environmental reaction CO_{2(aq)}+H₂O [symbol] H₂CO₃ [symbol] HCO₃⁻+H⁺ [symbol] CO₃²⁻+2 H⁺ containing ionized hydrogen gas (H+) feed stock input 12, hydrogen gateway coil 13, pem fuel cell tubing 14, O₂ from air pump 15, exhaust hydrogen and water vapor from fuel cell 16, return vacuum tubing to 17, dissociated seawater in collection tank 18, returning de-acidified seawater to ocean feedstock 19, dissociated seawater 20, + voltage from dissociator 21, − voltage from dissociator 22, titanium electrical conductors 23, copper electrical conductors 24, acidified seawater 25, hydrogen gas (H₂) extraction filters 26 in the process FIG. 1.

When acidified seawater 12 is pumped 5 into the seawater dissociator 7 the electrical conductors 24, 23 dissociate the acidified seawater 25. The output 20 of dissociator 7 is dissociated seawater 20 and input to hydrogen collection tank 8. The hydrogen collection tank diffuser 11 with its −12 volts 3 is used to gather all hydrogen H₂ molecules at top of the collection tank 8. The dissociated seawater is keep at minimal level 18 in collection tank 8. The hydrogen gateway coil 13 with its −12 volts is used to collect H₂ only and further restrict negative charged ions in 8 from entering for vacuum tube 14 transport to PEM fuel cell 4. Hydrogen (H₂) molecules and allowed to combine at the fuel cell 4 with the atmospheric O₂ 15 pumped 9 into the fuel cell 4 from the air pump 9. Any exhaust H₂ gases 16 from the fuel cell 4 as well as moisture are output to the vacuum pump 10. The vacuum pump 10 transports the exhaust gases 17 back into the hydrogen collection tank 8. Solar PV panel 1, charge inverter controller 2, and power supply 3 are used to supply system power in FIG. 1. The acidified seawater input 12 is continually circulated into the collection tank 8 where it is de-acidified 7 and returned safely to the ocean 19. The hydrogen production processes of FIG. 1 will return all of the elements in seawater feedstock 12 harmless minus the hydrogen ions H+ to marine life improving the ocean chemistry from acidification.

1. What I claim as my invention is production of hydrogen gas (H₂) from seawater and the hydrogen gas production, extraction, and removal by:
a acidified seawater feedstock,
a system for the production of hydrogen gas (H₂) from dissociated seawater,
a seawater feedstock input from a salt water ocean,
a hydrogen collection system for hydrogen gas (H₂) in the use by PEM fuel cells,
a method for storing hydrogen gas (H₂) from the seawater feedstock,
a method for returning the seawater after the production of hydrogen gas (H₂) from the seawater feedstock back into the ocean environment,
a self-contained, sealed, transportable, autonomous vessel for input of seawater feedstock, hydrogen gas (H₂) production, returning the non-acidified feedstock back to the ocean, and
an atomic species of hydrogen gas (H₂) for energy use to a receiving fuel cell or other custom power conversion technology.

2. The hydrogen gas (H₂) production process of claim 1, wherein said dissociation of seawater feedstock.

3. The seawater for hydrogen gas (H₂) production of claim 1, wherein said seawater feedstock, hydrogen gas piping, water pumps, vacuum pump, air pumps, dissociator with control circuitry, seawater piping connections, hydrogen gas, storage tanks, and input power are integrated into common integrated processing equipment system.

4. The seawater system of claim 1, wherein said production of hydrogen gas (H₂) from acidified seawater feedstock is made safe for return into the ocean environment.
